(19) United States
(12) Patent Application Publication
(10) Pub. No.: US 2021/0067342 A1
(43) Pub. Date: Mar. 4, 2021

(54) Decentralized Generation and Management of Product Identifiers and Metadata

(71) Applicant: EVRYTHNG Ltd., London (GB)

(72) Inventors: Dominique Guinard, Yverdon-les-Bains (CH); Joel Vogt, Commungy (CH); Niall Murphy, London (GB); Shmuel Silverman, Novato, CA (US)

(73) Assignee: EVRYTHNG Ltd., London (GB)

(21) Appl. No.: 16/560,953

(22) Filed: Sep. 4, 2019

(51) Int. Cl. H04L 9/32; H04L 9/06; H04L 9/08

(52) U.S. Cl. CPC H04L 9/3213; H04L 2209/38; H04L 9/0866; H04L 9/0643

(57) ABSTRACT

A computer system is described. This computer system may include: a network interface that communicates with an electronic device (which may be remotely located from the computer system); a processor; and memory that stores program instructions. During operation, the computer system may generate, in a decentralized manner, a globally unique product identifier for a product based at least in part on a smart contract. For example, the smart contract may be based at least in part on a blockchain. Moreover, the globally unique product identifier may be globally authenticated or may be capable of global authentication. Then, the computer system may associate the globally unique product identifier, one-to-one or many-to-one, with a non-fungible token (NFT) based at least in part on the smart contract. Next, the computer system may provide the globally unique product identifier intended for an electronic device associated with a recipient or a client.

### BACKGROUND

### Field

The described embodiments relate to product identifiers, supply chain and global commerce. Notably, the described embodiments relate techniques that facilitate decentralized generation and querying of product identifiers and associated metadata.

### Related Art

Currently, product identifiers for consumer packaged goods (CPG), fresh food, apparel and pharmaceutical products usually take the form of so-called global trade item numbers (GTINs) or codes that are delivered by a network of non-profit organizations under the Global Standards 1 (GS1) umbrella. Notably, there may be local GS1 organizations in a large number of countries and a central GS1 global office that coordinates their efforts. The delivered GTINs are usually written into machine-readable codes using 1D barcodes, which are sometimes referred to as European article number codes (EANs), universal product codes (UPCs) or GTINs.

Moreover, a number of alternatives to GS1 exist, such as Amazon standard identification number or ASIN (provided by Amazon.com, Inc. of Seattle, Wash.). Similarly, e-commerce platforms, such as Alibaba (from the Alibaba Group Holding Ltd. of Hangzhou, China) or eBay (of San Jose, Calif.), generate unique product identifiers in a centralized manner. These approaches for centrally delivered product identifiers have been used for many years and have facilitated the development of global commerce and supply chains.

However, there are challenges associated with the use of centrally delivered product identifiers. Notably, many of the centralized approaches use a set of predefined rules that are often hard to enforce and check. Moreover, many organizations do not usually deliver codes for each product. Instead, these organizations typically deliver ranges of identifiers to a company that buys a range. The companies are then often responsible for managing how they assign these codes. Note that these centralized approaches may result in a number of duplicate product identifiers, either because the product identifiers were inadvertently copied or because of intentional and malicious copying of product identifiers.

Furthermore, in many of the centralized approaches there may not be a single repository or location where the ‘truth’ about product identifier and its associated metadata (which is sometimes called ‘master data’) is stored. Consequently, while the centrally delivered product identifiers are usually sufficient for use in supply chains, they are often not meaning for consumers and, thus, are typically not used in the consumer space.

Additionally, centrally delivered product identifiers usually belong to a single entity with full control of the product identifiers and the associated metadata. However, centrally delivered product identifiers are often not recognized outside of the central entities that delivered them. Consequently, centrally delivered product identifiers are typically not globally accepted or used.

### SUMMARY

In a first group of embodiments, a computer system is described. This computer system may include: a network interface that communicates with an electronic device (which may be remotely located from the computer system); a processor; and memory that stores program instructions. During operation, the computer system may generate, in a decentralized manner, a globally unique product identifier for a product based at least in part on a smart contract. Then, the computer system may associate the globally unique product identifier one-to-one or many-to-one with a non-fungible token (NFT) based at least in part on the smart contract. Next, the computer system may provide the globally unique product identifier intended for the electronic device associated with a recipient.

Note that the globally unique product identifier may be globally authenticated or may be capable of global authentication.

Moreover, the smart contract may be based at least in part on a blockchain.

Furthermore, the globally unique product identifier may be generated as part of a sequential group of globally unique product identifiers or may be generated non-sequentially from another globally unique product identifier.

Additionally, the NFT may be immutable.

In some embodiments, the globally unique product identifier may be assigned to a set of globally unique product identifiers that are associated with the NFT.

Note that the globally unique product identifier may be compatible with one or more of: a GS1 Digital Link, a GTIN, a serial shipping container (SSCC), a serialized global trade item number (SGTIN), an EAN, a UPC, an electronic product code (EPC), a global location number (GLN), an international standard book identifier (ISBN), a global returnable assess identifier (GRAI), a global coupon number (GCN), an Amazon standard identification number (ASIN), a global returnable asset identifier (GRAI), a global shipment identification number (GSIN), a universally unique identifier (UUID), a global document type identifier (GDTY), a globally unique identifier (GUID), an Eddystone UID or EID, an international mobile equipment identity (IMEI), an eSIM identifier, or a pharmaceutical product identifier (PhPID).

Moreover, the globally unique product identifier may be generated randomly or pseudo-randomly.

Furthermore, the computer system may receive a request for a desired number of globally unique product identifiers that is associated with the electronic device, and the globally unique product identifier may be generated based at least on the request. Note that prior to the receiving, the computer system may perform a transaction that transfers value (or a token having the value) associated with the smart contract.

In some embodiments, instead of generating the globally unique product identifier, the globally unique product identifier may be predetermined or pre-generated. For example, the computer system may select a predetermined globally unique product identifier.

Moreover, in some embodiments, the computer system may associate, using a blockchain, product metadata for a globally unique product identifier and may retrieve the product metadata for the globally unique product identifier in a decentralized manner.

Furthermore, in some embodiments, the computer system may securely transfer one or more globally unique product identifiers between authenticated owners.

Additionally, in some embodiments, the computer system may generate a set of globally unique product identifiers, with one or more globally unique product identifiers, using a smart contract based at least in part on a blockchain. Prior to generating the set of globally unique product identifiers, the computer system may generate an NFT as an identifier of the set of globally unique product identifiers. Moreover, a given globally unique product identifier in the set of globally unique product identifiers may have a one-to-one association with a globally unique NFT. Furthermore, the computer system may store the set of globally unique product identifiers on a blockchain or in a decentralized database in which a given globally unique product identifier is retrievable based at least in part on the associated NFT.

Note that the computer system may store public metadata and/or private metadata, either of which may be associated with the set of globally unique product identifiers. The computer system may provide the public metadata associated with a given globally unique product identifier in response to receiving the given globally unique product identifier or the associated NFT. Alternatively, the computer system may return and/or allow updates to the public metadata and/or the private metadata in response to receiving a given globally unique product identifier or the associated NFT. In some embodiments, the computer system may enable global access and alterations to the public metadata and/or the private metadata via a distributed ledger and a decentralized or distributed database.

Moreover, the given globally unique product identifier may be globally unique via a smart contract and a distributed ledger.

In some embodiments, the computer system provides code translations between a globally unique product identifier and a printable representation. The printable representation may be compatible with one or more of: a GS1 Digital Link, a GTIN, an SSCC, an SGTIN, an EAN, a UPC, an EPC, a GLN, an ISBN, a GRAI, a GCN, an ASIN, a GRAI, a GSIN, a UUID, a GDTY, a GUID, an Eddystone UID or EID, an IMEI, an eSIM identifier, or a PhPID.

Furthermore, in some embodiments, the computer system may provide a separate ledger with one or more smart contracts that is used to map between an NFT and multiple contained NFTs. Note that the mapping may or may not use a decentralized database.

Additionally, in some embodiments, the computer system may tack, store product metadata and/or update a color code associated with a product based at least in part on an environment history of the product. For example, the color code may be based at least in part in an environmental specification associated with the product.

Another embodiment provides a computer-readable storage medium for use with the computer system. When executed by the computer system, this computer-readable storage medium causes the computer system to perform at least some of the aforementioned operations.

Another embodiment provides a method, which may be performed by the computer system. This method includes at least some of the aforementioned operations.

In a second group of embodiments, a client or an electronic device that controls a globally unique product identifier using an asymmetrically encrypted signature is described.

Another embodiment provides a computer-readable storage medium for use with the client or the electronic device. When executed by the client or the electronic device, this computer-readable storage medium causes the client or the electronic device to perform at least some of the aforementioned operations.

Another embodiment provides a method, which may be performed by the client or the electronic device. This method includes at least some of the aforementioned operations.

In a third group of embodiments, a computer system is described. This computer system may include: a network interface that communicates with an electronic device (which may be remotely located from the computer system); a processor; and memory that stores program instructions. During operation, the computer system may select, in a decentralized manner, a predetermined globally unique product identifier for a product based at least in part on a smart contract. Then, the computer system may associate the globally unique product identifier one-to-one or many-to-one with an NFT based at least in part on the smart contract. Next, the computer system may provide the globally unique product identifier intended for the electronic device associated with a recipient.

Another embodiment provides a method, which may be performed by the computer system. This method includes at least some of the aforementioned operations.

Another embodiment provides a computer-readable storage medium for use with the computer system. When executed by the computer system, this computer-readable storage medium causes the computer system to perform at least some of the aforementioned operations.

In a fourth group of embodiments, a client or an electronic device that associates, using a blockchain, product metadata for a globally unique product identifier and that retrieves the product metadata for the globally unique product identifier in a decentralized manner is described.

Another embodiment provides a computer-readable storage medium for use with the client or the electronic device. When executed by the client or the electronic device, this computer-readable storage medium causes the client or the electronic device to perform at least some of the aforementioned operations.

Another embodiment provides a method, which may be performed by the client or the electronic device. This method includes at least some of the aforementioned operations.

In a fifth group of embodiments, a computer that securely transfers one or more globally unique product identifiers between authenticated owners is described.

Another embodiment provides a method, which may be performed by the computer. This method includes at least some of the aforementioned operations.

Another embodiment provides a computer-readable storage medium for use with the computer. When executed by the computer, this computer-readable storage medium causes the computer to perform at least some of the aforementioned operations.

In a sixth group of embodiments, a computer that generates a set of globally unique product identifiers, with one or more globally unique product identifiers, using a smart contract based at least in part on a blockchain is described.

Moreover, prior to generating the set of globally unique product identifiers, the computer may generate an NFT as an identifier of the set of globally unique product identifiers. Note that a given globally unique product identifier in the set of globally unique product identifiers may have a one-to-one association with a globally unique NFT.

Furthermore, the computer may store the set of globally unique product identifiers on a blockchain or in a decentralized database in which a given globally unique product identifier is retrievable based at least in part on an associated NFT.

Additionally, the computer may store public metadata, private metadata or both, either of which is associated with the set of globally unique product identifiers.

In some embodiments, the computer may provide the public metadata associated with a given globally unique product identifier in response to receiving the given globally unique product identifier or an associated NFT.

Moreover, the computer may return and allow updates to the public metadata, the private metadata or both in response to receiving a given globally unique product identifier or an associated NFT.

Furthermore, the computer may enable global access and alterations to the public metadata, the private metadata or both via a distributed ledger and a decentralized or distributed database.

Note that a given globally unique product identifier may be globally unique via a smart contract and a distributed ledger.

Another embodiment provides a method, which may be performed by the computer. This method includes at least some of the aforementioned operations.

Another embodiment provides a computer-readable storage medium for use with the computer. When executed by the computer, this computer-readable storage medium causes the computer to perform at least some of the aforementioned operations.

In a seventh group of embodiments, a computer that provides code translations between a globally unique product identifier and a printable representation is described.

Note that the printable representation may be compatible with one of: a GS1 Digital Link, a GTIN, an SSCC, an SGTIN, an EAN, a UPC, an EPC, a GLN, an ISBN, a GRAI, a GCN, an ASIN, a GRAI, a GSIN, a UUID, a GDTY, a GUID, an Eddystone UID or EID, an IMEI, an eSIM identifier, or a PhPID

Another embodiment provides a method, which may be performed by the computer. This method includes at least some of the aforementioned operations.

Another embodiment provides a computer-readable storage medium for use with the computer. When executed by the computer, this computer-readable storage medium causes the computer to perform at least some of the aforementioned operations.

In a seventh group of embodiments, a computer that provides a separate ledger with one or more smart contracts that is used to map between an NFT and multiple contained NFTs is described.

Note that the mapping may not use a decentralized database.

Another embodiment provides a method, which may be performed by the computer. This method includes at least some of the aforementioned operations.

Another embodiment provides a computer-readable storage medium for use with the computer. When executed by the computer, this computer-readable storage medium causes the computer to perform at least some of the aforementioned operations.

In an eighth group of embodiments, a computer that tracks, stores in product metadata and updates a color code associated with a product based at least in part on an environment history of the product is described.

Note that the color code may be based at least in part in an environmental specification associated with the product. For example, the color code may be used to indicate when the product has been exposed to a temperature or a humidity exceeding a specification for the product, such as a maximum temperature or humidity or an average temperature or humidity over a time interval corresponding to an ability of the product to be unaffected by the temperature or the humidity.

Another embodiment provides a method, which may be performed by the computer. This method includes at least some of the aforementioned operations.

Another embodiment provides a computer-readable storage medium for use with the computer. When executed by the computer, this computer-readable storage medium causes the computer to perform at least some of the aforementioned operations.

In a ninth group of embodiments, a computer system that performs a transaction that transfers value associated with a smart contract is described.

Another embodiment provides a method, which may be performed by the computer system. This method includes at least some of the aforementioned operations.

Another embodiment provides a computer-readable storage medium for use with the computer system. When executed by the computer system, this computer-readable storage medium causes the computer system to perform at least some of the aforementioned operations.

In a tenth group of embodiments, a computer system that transferring ownership, between authenticated entities, of a globally unique product identifier based at least in part on an NFT is described.

Another embodiment provides a method, which may be performed by the computer system. This method includes at least some of the aforementioned operations.

Another embodiment provides a computer-readable storage medium for use with the computer system. When executed by the computer system, this computer-readable storage medium causes the computer system to perform at least some of the aforementioned operations.

In an eleventh embodiments a computer system that provides an NFT is described. This computer system may include: a network interface that communicates with an electronic device (which may be remotely located from the computer system); a processor; and memory that stores program instructions. During operation, the computer system may receive a unique identifier for a product associated with the electronic device. Then, the computer system may generate, in a decentralized manner, a globally unique product identifier for the product based at least in part on a smart contract. Moreover, the computer system may associate the unique identifier and the globally unique product identifier one-to-one or many-to-one with an NFT based at least in part on a smart contract. Next, the computer system may provide the NFT intended for the electronic device associated with a recipient, where the NFT facilitates management of the globally unique product identifier.

Another embodiment provides a method, which may be performed by the computer system. This method includes at least some of the aforementioned operations.

Another embodiment provides a computer-readable storage medium for use with the computer system. When executed by the computer system, this computer-readable storage medium causes the computer system to perform at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for generating a globally unique produce identifier using the computer system of FIG. 1 in accordance with an embodiment of the present disclosure.

FIG. 3 is a drawing illustrating an example of communication among electronic devices in FIG. 1 in accordance with an embodiment of the present disclosure.

FIG. 4 is a drawing illustrating an example of decentralized generation of a globally unique product identifier in accordance with an embodiment of the present disclosure.

FIG. 5 is a drawing illustrating an example of mapping one or more unique NFTs to a set of globally unique product identifiers in accordance with an embodiment of the present disclosure.

FIG. 6 is a drawing illustrating an example of one-to-one mapping of a globally unique product identifier to an NFT in accordance with an embodiment of the present disclosure.

FIG. 7 is a drawing illustrating an example of requesting metadata associated with a globally unique product identifier using a private key in accordance with an embodiment of the present disclosure.

FIG. 8 is a drawing illustrating an example of requesting metadata associated with a globally unique product identifier without using a private key in accordance with an embodiment of the present disclosure.

FIG. 9 is a drawing illustrating an example of retrieving a globally unique product identifier in accordance with an embodiment of the present disclosure.

FIG. 10 is a drawing illustrating an example of performing a transaction that transfers value associated with a smart contract in accordance with an embodiment of the present disclosure.

FIG. 11 is a drawing illustrating an example of associating a globally unique product identifier with an NFT in accordance with an embodiment of the present disclosure.

FIG. 12 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system (such as a network of computers) is described. This computer system may include: a network interface that communicates with an electronic device (which may be remotely located from the computer system); a processor; and memory that stores program instructions. During operation, the computer system may generate, in a decentralized manner, a globally unique product identifier for a product based at least in part on a smart contract. For example, the smart contract may be based at least in part on a blockchain. Moreover, the globally unique product identifier may be globally authenticated or may be capable of global authentication. Then, the computer system may associate the globally unique product identifier, one-to-one or many-to-one, with an NFT based at least in part on the smart contract. Next, the computer system may provide the globally unique product identifier intended for an electronic device associated with a recipient or a client.

By providing the globally authenticated, unique product identifier in a distributed manner, this identification technique may avoid problems with existing approaches. Notably, the identification technique may avoid or eliminate the need for a set of predefined rules that are currently used to create product identifiers. Moreover, the identification technique may avoid or eliminate duplicate product identifiers, and thus the globally unique product identifiers can be trusted. Furthermore, the resulting globally unique product identifiers may be used by consumers, and globally unique product identifiers may be compatible with existing product identifier approaches (such as GS1 identifiers) and may recognized by and/or used by multiple entities, organizations or companies. Consequently, the identification technique may provide improved product identifiers that can be flexibly and uniquely generated. This capability may improve supply chain management (e.g., by reducing confusion, errors and/or malicious actions, as well as the associated expenses) and consumer markets.

In some embodiments, the identification technique may provide globally unique product identifiers in a distributed or decentralized manner using a Distributed Ledger Technology (DLT), smart contracts and a decentralized database. Because of this decentralized technology (which may incorporate a consensus technique), trust in the globally unique product identifiers may be further enhanced. Moreover, the decentralized technology may allow the identities of companies that generate globally unique product identifiers for their products to be verified, e.g., using asymmetric encryption techniques. Furthermore, the decentralized technology may allow product metadata to be assigned or associated with the globally unique product identifiers, which may allow general access to this information, e.g., via public blockchains. Additionally, the decentralized technology may provide resilience, because the globally unique product identifiers and their associated metadata may be stored or maintained in a decentralized network that includes many nodes. The identification technique may also allow a single globally unique product identifier to be deployed using multiple graphical representations throughout the lifetime of a product and/or may allow globally unique product identifiers to be transferred between owners in a safe, secure and trusted manner. Therefore, the identification technique may facilitate an increase in commercial activity and may improve the user experience when using the globally unique product identifiers.

In the discussion that follows, electronic devices may communicate packets or frames with wired and/or wireless networks (e.g., via access points, radio nodes or base stations) in accordance with a wired communication protocol (such as an Institute of Electrical and Electronics Engineers or IEEE 802.3 standard, which is sometimes referred to as ‘Ethernet’, or another type of wired interface) and/or a wireless communication protocol, such as: an IEEE 802.11 standard (which is sometimes referred to as ‘Wi-Fi,’ from the Wi-Fi Alliance of Austin, Tex.), Bluetooth (from the Bluetooth Special Interest Group of Kirkland, Wash.), a cellular-telephone communication protocol (such as 2G, 3G, 4G, 5G, Long Term Evolution or LTE, another cellular-telephone communication protocol, etc.) and/or another type of wireless interface. In the discussion that follows, Wi-Fi, a cellular-telephone communication protocol and Ethernet are used as an illustrative example. However, a wide variety of communication protocols (such as) may be used. The wireless communication may occur in a variety of frequency bands, such as: a cellular-telephone communication band, a frequency band associated with a Citizens Band Radio Service, a Wi-Fi frequency band (such as a 2.4 GHz, a 5 GHz and/or a 60 GHz frequency band), etc.

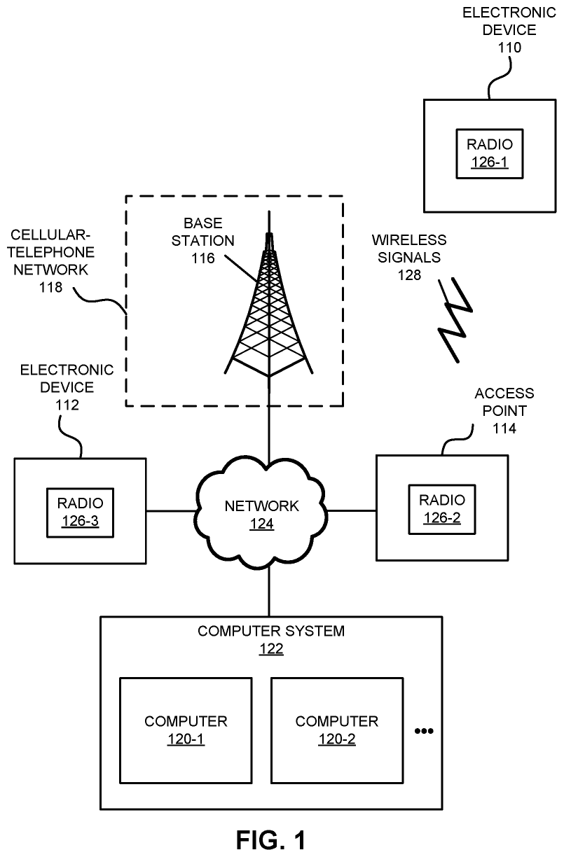

FIG. 1 presents a block diagram illustrating an example of communication among one or more of electronic devices 110 and 112 (such as a cellular telephone, a computer, etc., and which are sometimes referred to as ‘clients’), access point 114, base station 116 in cellular-telephone network 118, and one or more computers 120 in computer system 122 in accordance with some embodiments. Access point 114 and base station 116 may communicate with computer system 122 via network 124 (such as the Internet) using wireless and/or wired communication (such as by using Ethernet or a communication protocol that is compatible with Ethernet), and may communicate with electronic device 110 using wireless communication (Wi-Fi and a cellular-telephone communication protocol, respectively). Note that access point 114 may include a physical access point and/or a virtual access point that is implemented in software in an environment of an electronic device or a computer. In addition, access point 114 and/or base station 116 may communicate with electronic devices 110 using wireless communication, while electronic device 112 may communicate with computer system 122 via network 124.

While not shown in FIG. 1, the wired and/or wireless communication with electronic devices 110 and/or 112 may further occur via an intra-net, a mesh network, point-to-point connections, etc., and may involve one or more routers and/or switches. Furthermore, the wireless communication may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication in FIG. 1 also involves the use of dedicated connections, such as via a peer-to-peer (P2P) communication technique.

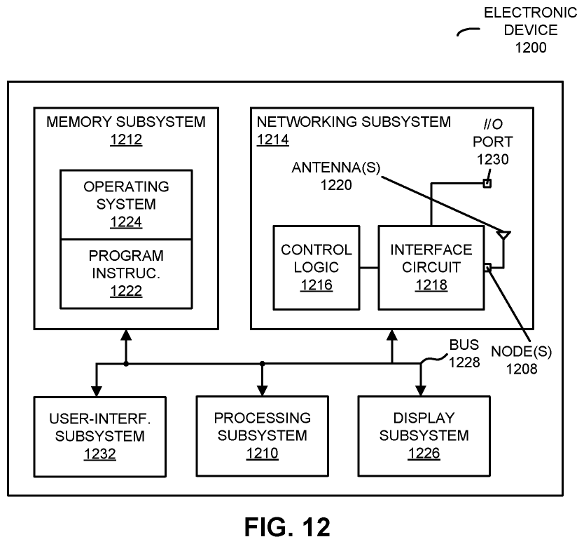

As described further below with reference to FIG. 12, electronic device 110, electronic device 112, access point 114, base station 116, and/or computers 120 may include subsystems, such as a networking subsystem, a memory subsystem and a processor subsystem. In addition, electronic device 110, access point 114 and base station 116 may include radios 126 in the networking subsystems. More generally, electronic device 110, electronic device 112 and access point 114 can include (or can be included within) any electronic devices with the networking subsystems that enable electronic device 110 and access point 114 to communicate with each other using wireless and/or wired communication. This wireless communication can comprise transmitting advertisements on wireless channels to enable access point 114 and/or electronic device 110 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 126 are shown in electronic device 110 and access point 114, one or more of these instances may be different from the other instances of radios 126.

As can be seen in FIG. 1, wireless signals 128 (represented by a jagged line) are transmitted from radio 126-1 in electronic device 110. These wireless signals may be received by radio 126-2 in access point 114. Notably, electronic device 110 may transmit packets or frames. In turn, these packets or frames may be received by access point 114. Moreover, access point 114 may allow electronic device 110 to communicate with other electronic devices, computers and/or servers via network 124.

Note that the communication among components in FIG. 1 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in electronic device 110 and/or access point 114 includes: receiving signals (such as wireless signals 128) with the packet or frame; decoding/extracting the packet or frame from received wireless signals 128 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, product identifiers (e.g., a GTIN, an ASIN, etc.) are at the heart of supply chains and global commerce. Today, these identifiers are typically issued online by a central entity or offline by organizations such as GS1. Furthermore, the metadata associated with products is usually stored in many different databases. This often leads to inefficiencies and errors. The disclosed identification technique provides a computer system that generates records and queries globally unique product identifiers and/or the associated metadata in a decentralized and fully automated manner. This identification technique may ensure unicity of the globally unique product identifiers, and may reduce inefficiencies and improve the worldwide availability of the globally unique product identifiers and their associated metadata.

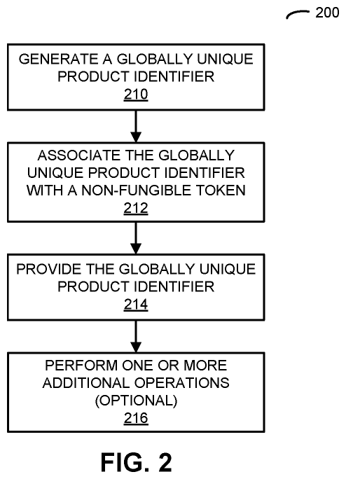

Notably, as described further below with reference to FIGS. 2-11, in the identification technique computer system 122 may optionally receive a request for a desired number of globally unique product identifiers that is associated with an electronic device (such as electronic device 110 or 112). In response, computer system 122 may generate, in a decentralized manner, a globally unique product identifier for a product based at least in part on a smart contract. (Alternatively, computer system 122 may select a pre-generated globally unique product identifier.)

Note that a ‘smart contract’ may be a computer protocol that digitally facilitates, verifies, or enforces the negotiation or performance of a contract. A smart contract may allow the performance of credible transactions without third party involvement. These transactions may be trackable and irreversible. For example, the smart contract may be based at least in part on a blockchain and, more generally, using a system in which a record of a transaction is made in bitcoin or another cryptocurrency that is maintained across several computers, and which are linked in a peer-to-peer network. In some embodiments, the smart contract may be based at least in part on another technology, such as Ethereum, a hybrid of bitcoin and Ethereum, a dual layer technique with a control layer that supports a smart contract and which is separate from a cryptocurrency layer, etc.

Then, computer system 122 may associate the globally unique product identifier one-to-one or many-to-one with an NFT based at least in part on the smart contract. Next, computer system 122 may provide the globally unique product identifier intended for an electronic device associated with a recipient (such as electronic device 110 or 112).

Note that the globally unique product identifier may be globally authenticated or may be capable of global authentication. Moreover, the globally unique product identifier may be generated as part of a sequential group of globally unique product identifiers or may be generated non-sequentially from another globally unique product identifier. Furthermore, the NFT may be immutable. In some embodiments, the globally unique product identifier may be assigned to a set of globally unique product identifiers that are associated with the NFT.

The globally unique product identifier may be compatible with one or more of: a GS1 Digital Link, a GTIN, an SSCC, an SGTIN, an EAN, a UPC, an EPC, a GLN, an ISBN, a GRAI, a GCN, an ASIN, a GRAI, a GSIN, a UUID, a GDTY, a GUID, an Eddystone UID or EID, an IMEI, an eSIM identifier, or a PhPID. Moreover, the globally unique product identifier may be generated randomly or pseudo-randomly.

In these ways, computer system 122 may provide globally unique product identifiers in a flexible and distributed manner, without using predefined rules and/or duplicate product identifiers. Consequently, computer system 122 may enhance trust in the globally unique product identifiers, and may expand their use across organizations and/or by consumers.

We now describe embodiments of a method. FIG. 2 presents a flow diagram illustrating an example of a method 200 for generating a globally unique produce identifier using a computer system, such as computer system 100 (FIG. 1). During operation, the computer system (such as one or more computers in the computer system) may generate, in a decentralized manner, a globally unique product identifier (operation 210) for a product based at least in part on a smart contract. Then, the computer system may associate the globally unique product identifier one-to-one or many-to-one with an NFT (operation 212) based at least in part on the smart contract. Next, the computer system may provide the globally unique product identifier (operation 214) intended for the electronic device associated with a recipient.

In some embodiments, the computer system may optionally perform one or more additional operations (operation 216). For example, the computer system may receive a request for a desired number of globally unique product identifiers that is associated with the electronic device, and the globally unique product identifier may be generated based at least on the request. Alternatively, instead of generating the globally unique product identifier (operation 210), the globally unique product identifier may be predetermined or pre-generated. For example, the computer system may select a predetermined globally unique product identifier.

In some embodiments of method 200, there may be additional or fewer operations. Furthermore, the order of the operations may be changed, there may be different operations and/or two or more operations may be combined into a single operation.

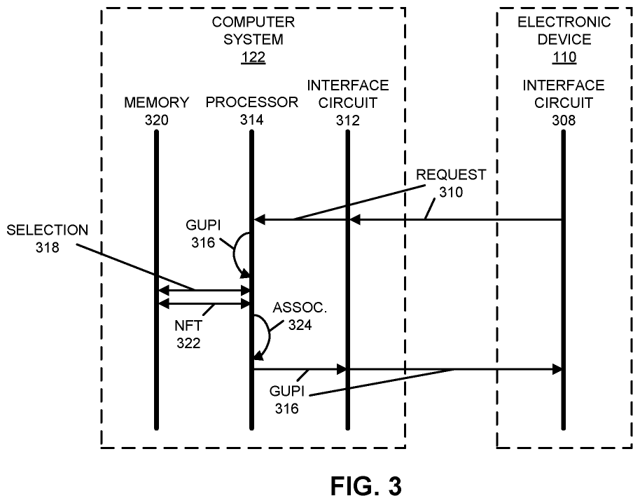

FIG. 3 presents a drawing illustrating an example of communication among electronic device 110 and computer system 122. During the identification technique, an interface circuit 308 in electronic device 110 may provide a request 310 for a desired number of globally unique product identifiers to computer system 122.

After interface circuit 312 in computer system 122 receives request 310, it may provide request 310 to processor 314 in computer system 122. Processor 314 may execute program instructions that cause computer system 122 to perform at least some of the operations in the identification technique. Notably, in response to request 310, processor 314 may generate, in a decentralized manner, a globally unique product identifier (GUPI) 316 for a product based at least in part on a smart contract. Alternatively, instead of generating the globally unique product identifier 316, processor may select 318 a predetermined or pre-generated globally unique product identifier 316 that is stored in memory 320 in computer system 122.

Then, processor 314 may associate 324 the globally unique product identifier 316 one-to-one or many-to-one with an NFT 322 based at least in part on the smart contract. For example, processor 314 may access NFT 322 in memory 320 in computer system 122.

Next, processor 314 may provide the globally unique product identifier 316 to interface circuit 312, which may then provide the globally unique product identifier 316 to interface circuit 308.

While FIG. 3 illustrates communication between components using unidirectional or bidirectional communication with lines having single arrows or double arrows, in general the communication in a given operation in these figures may involve unidirectional or bidirectional communication.

We now further describe embodiments of the identification technique. During the identification technique, a computer system (such as computer system 122 in FIG. 1) may identify a client (such as electronic device 110 or 112 in FIG. 1) via an electronic asymmetric encrypted signature. This client may request one or more globally unique product identifiers for their products. In response to the request, the computer system (such as one or more computers in the computer system) may generate a set of globally unique product identifiers (which may include one or more globally unique product identifiers) using at least a smart contract based at least in part on a blockchain. Note that each of the globally unique product identifiers may be globally unique via a smart contract and a distributed ledger. (A distributed ledger which is sometimes referred to as a ‘shared ledger’ or a ‘distributed ledger technology’, is a consensus of replicated, shared, and synchronized digital data geographically spread across multiple sites, countries, and/or institutions. Typically, there is no central administrator or centralized data storage in a distributed ledger.) Then, the computer system may store private and/or public metadata associated with the set of globally unique product identifiers. Next, the computer system may map the set of globally unique product identifiers, one-to-one or many-to-one, to an NFT that is globally unique, such as an Ethereum token (e.g., an ERC721 token).

Moreover, when a client provides a globally unique product identifier or an NFT, the computer system may return the public metadata associated with this globally unique product identifier or NFT. Furthermore, when a client provides a globally unique product identifier or NFT, and a signature, the computer system may return and allow update to the public and the private metadata associated with this globally unique product identifier or NFT. The computer system may, therefore, enable global access and/or modification to the metadata using a distributed ledger and a decentralized (e.g., distributed) data structure or database, which may use a peer-to-peer file system (such as an InterPlanetary File System or IPFS, from Protocol Labs, Inc.).

Additionally, the set of globally unique product identifiers may be securely transferred to a different owner. In some embodiments, the identification technique may facilitate code translations between globally unique product identifiers and printable representations, such as: a GS1 Digital Link, a GTIN, an SSCC, an SGTIN, an EAN, a UPC, an EPC, a GLN, an ISBN, a GRAI, a GCN, an ASIN, a GRAI, a GSIN, a UUID, a GDTY, a GUID, an Eddystone UID or EID, an IMEI, an eSIM identifier, a PhPID, etc.

Note that a separate ledger with smart contracts may be used to map between an NFT and multiple contained NFTs. These embodiments may be similar to how a wallet can contain different instances of and/or types of currency.

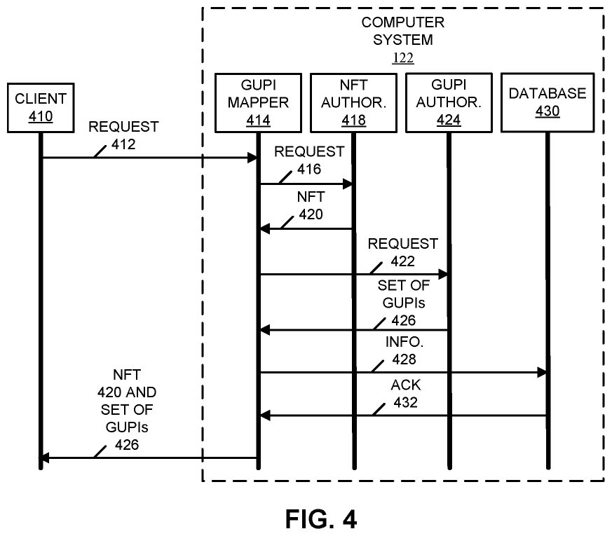

FIG. 4 presents a drawing illustrating an example of decentralized generation of a globally unique product identifier in accordance with an embodiment of the present disclosure. These operations may, at least in part, be performed by one or more computers in a computer system, such as computer system 122 (FIG. 1).

Notably, a set of globally unique product identifiers (with one or more globally unique product identifiers) may be generated and mapped to and from an NFT using one or more smart contracts. If a request for the set of globally unique product identifiers includes or identifies associated metadata, then the metadata may be stored in a decentralized data structure or database and may be uniquely associated with the set of globally unique product identifiers.

Moreover, a given globally unique product identifier provided to the client may be used as a code for a product. There may be a one-to-one association between the given globally unique product identifier and the NFT. However, in some embodiments, there may be one-to-many and many-to-one associations between a set of globally unique product identifiers and the NFT. In embodiments in which there are many globally unique product identifiers associated with a single NFT, smart contract information may be used to resolve duplication and single-usage problems. More generally, there may be a hierarchical mapping of NFTs. For example, because one-to-many and many-to-one mappings of globally unique product identifiers and an NFT are supported, each globally unique product identifier may be associated with an NFT, and this NFT may, in turn, by mapped to many other NFTs or any of those NFTs may be mapped back to a single NFT.

As shown in FIG. 4, client 410 (such as electronic device 110 or 112 in FIG. 1, or a component implemented in electronic device 110 or 112 in FIG. 1) may generate or provide (not shown) a public/private key pair in asymmetric cryptography that can be used to authenticate and sign requests in the identification technique. (However, in other embodiments, symmetric cryptography may be used.) Note that client 410 may be a software tool (such as a metadata management tool, enterprise resource planning software, etc.) that provides a request 412 to computer system 122. Note that request 412 may include a key (such as the public key, which may function as a signature of client 410), a count (such as a number of globally unique product identifiers requested in a single transaction), public metadata and/or private metadata.

After receiving request 412, a globally unique product identifier (GUPI) mapper 414 in computer system 122 may sent a request 416 with the key to NFT authority 418 to obtain a single NFT 420. This NFT may be subsequently used to facilitate the transfer of a set of globally unique product identifiers.

Then, GUPI mapper 414 may request 422 that GUPI authority 424 generate a set of globally unique product identifiers (GUPIs) 426 that include a number of globally unique product identifiers equal to the count, and to associate the set of GUPIs 426 with NFT 420. Note that NFT 420 may be associated with the entire set of GUPIs 426. This association may be bidirectional, and may be one-to-many and/or many-to-one.

Moreover, GUPI mapper 414 may associate the public metadata and/or private metadata with NFT 420 and the key, and may save this information 428 in decentralized database (or data structure) 430. In response, database 430 may provide an acknowledgment (ACK) 432 to GUPI mapper 414.

Next, GUPI mapper 414 may provide NFT 420 and the set of GUPIs 426 to client 410.

Table 1 provides an example pseudocode for the operations shown in FIG. 4.

TABLE 1

Client −> GUPI mapper: Request (key, count, public metadata,
private metadata)
GUPI mapper −> NFT: Request (key)
NFT −> GUPI mapper: NFT
GUPI mapper −> GUPI authority: (NFT, count)
GUPI authority −> GUPI mapper: {set of GUPIs}
GUPI mapper −> Database: (key, NFT, public metadata, private
metadata)
Database −> GUPI mapper: Acknowledgement
GUPI mapper −> Client: {set of GUPIs}, NFT

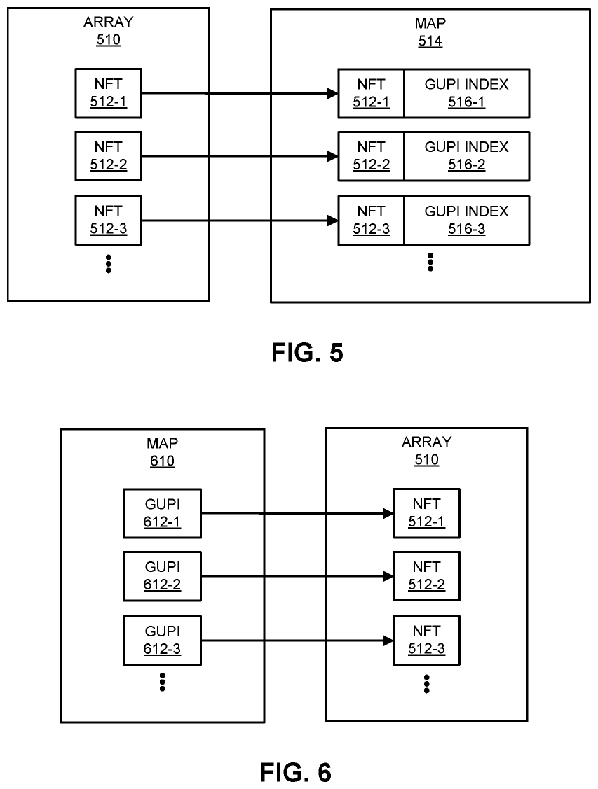

FIG. 5 presents a drawing illustrating an example of mapping one or more unique NFTs to a set of globally unique product identifiers, e.g., one-to-one or one-to-many, in accordance with an embodiment of the present disclosure. These operations may, at least in part, be performed by one or more computers in a computer system, such as computer system 122 (FIG. 1).

As described previously, a set of globally unique product identifiers (which may include one or more globally unique product identifiers) can be addressed using a single NFT, and a single NFT may be reached from multiple different globally unique product identifiers. As an analogy, this process may be represented by a tree that may be navigated using a hash-based data structure, which may be a generalization of a hash list. The hash list may directly point to data members in the tree (e.g., leaf nodes). This illustrates the embodiments of one-to-one mapping between an NFT and a given globally unique product identifier. Similarly, a one-to-one mapping may be created between the given globally unique product identifier and an NFT. Because the hash functions of the hash table are unique, an input to hash table (such as the client key) may be unique, but the data that it points to does not need to be unique.

The identification technique may need to support a data structure with a map of a unique NFT to a set of globally unique product identifiers (with one or more globally unique product identifiers). In order to enable this data structure, a linked list of pointers from a single NFT to a separate list of records with information associated with and/or that specifies one or more globally unique product identifiers may be needed. As shown in FIG. 5, array 510 (e.g., a linked pointer list) may store instances of NFTs 512. Moreover, map 514 may store associations between NFTs 512 and corresponding GUPI indexes 516. For example, array 510 may store pointers to indexes 516 of GUPIs in map 514. Note that GUPIs may be globally unique. Moreover, note that additional information may be added into a given record in array 510.

As shown in FIG. 5, every record for a given GUPI may include the NFT associated with it (which, in this example, is a single NFT). Moreover, a given record in array 510 may include an NFT and a pointer to the detailed information record in map 514. Furthermore, array 510 may be continuous for all of NFTs 512 and, thus, may be searched within O(log(N)) steps.

Additionally, the identification technique may need to support a data structure with a map from a given globally unique product identifier to an NFT. This is shown in FIG. 6, which presents a drawing illustrating an example of one-to-one mapping of a globally unique product identifier to an NFT in accordance with an embodiment of the present disclosure. These operations may, at least in part, be performed by one or more computers in a computer system, such as computer system 122 (FIG. 1).

Notably, one-to-one map 610 may be used in embodiments where given one of GUPIs 612 (such as GUPI 612-1), a corresponding one of NFTs 512 (such as NFT 512-1) may be requested or identified. The GUPIs 612 in map 610 may be unique, but the NFTs 512 may include duplicates. For example, more than one of GUPIs 612 may point to a common NFT. This may occur more than one GUPIs 612 in a set of globally unique product identifiers is identified by a single NFT (as described previously).

In summary, using the data structures shown in FIGS. 5 and 6, one-to-one and one-to-many maps of data may be implemented in the identification technique.

Table 2 provides an example pseudocode for implementing an iterable map with bidirectional links.

TABLE 2
contract AddressToMap {

struct Entry {

uint index; // index start 1 to keyList.length
bytes256 value;

}
mapping(address => Entry) internal map;
address[ ] internal keyList;
function add(address _key, bytes256 _value) public {

Entry storage entry = map[_key];
entry.value = _value;
if(entry.index > 0){ // entry exists

// do nothing
return;

} else {// new entry

keyList.push(_key);
uint keyListIndex = keyList.length − 1;
entry.index = keyListIndex + 1;

}

}
function remove(address _key) public {

Entry storage entry = map[_key];
require(entry.index != 0); // entry not exist
require(entry.index <= keyList.length); // invalid index value
// Move a last element of array into the vacated key slot.
uint keyListIndex = entry.index − 1;
uint keyListLastIndex = keyList.length − 1;
map[keyList[keyListLastIndex]].index = keyListIndex + 1;
keyList[keyListIndex] = keyList[keyListLastIndex];
keyList.length--;
delete map[_key];

}
function size( ) public view returns (uint) {

return uint(keyList.length);

}
function contains(address _key) public view returns (bool) {

return map[_key].index > 0;

}
function getByKey(address _key) public view returns (bytes256) {

return map[_key].value;

}
function getByIndex(uint _index) public view returns (bytes256) {

require(_index >= 0);
require(_index < key List.length);
return map[keyList[_index]].value;

}
function getKeys( ) public view returns (address[ ]) {

return keyList;

}

}

The pseudocode in Table 2 may be used to map a single NFT with a set of globally unique product identifiers and to provide iteration capabilities.

Note that the NFT may be used as a pointer to an array of indices that facilitates searches within a given mapping. However, in other embodiments, a wide variety of inputs may be associated with a set of globally unique product identifiers and used to facilitate searches. During a search technique, a computer in the computer system may identify a first index that includes a searched NFT. Then, the computer in the computer system may obtain a globally unique product identifier and an index record i. Next, the computer in the computer system may fetch an instance of an NFT in the index i at the beginning of the set of globally unique product identifiers. Moreover, the computer in the computer system may iterate through additional instances of NFTs and may fetch the globally unique product identifiers until an instance of an NFT associated with a record or index is not equal to the requested NFT.

In some embodiments, a one-to-one mapping smart contract may be used, and the data may be mapped into a tree-based decentralized database (or data structure). This database may be used to map many-to-many in any order and can be used to store relationships between NFT(s) and sets of globally unique product identifiers.

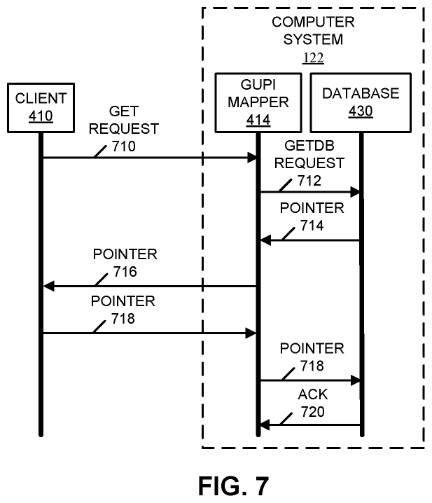

FIG. 7 presents a drawing illustrating an example of requesting metadata associated with a globally unique product identifier using a private key in accordance with an embodiment of the present disclosure. These operations may, at least in part, be performed by one or more computers in a computer system, such as computer system 122 (FIG. 1).

In general, product metadata may include private descriptions (which may be accessed by one or more designated recipients), public description (which may be accessed by an arbitrary recipient), or any other information pertaining to this product. For example, the metadata may include: a product manufacturer, a product description, a product size, one or more pictures, one or more manuals, nutritional facts, an expiration date, a temperature or environmental limitations, additional information, and/or associating code colors with environmental conditions or an environmental history. For example, a stored code color of ‘red’ may indicate that a temperature of a product exceeded a maximum temperature, so that the product has automatically expired. In some embodiments, the product metadata may be compatible with a standard, such as a schema.org product schema, GS1 GDSN data, etc. This capability may facilitate improved interoperability.

The computer system may allow metadata to be added or modified for a given product when the corresponding NFT and signature are provided. For example, a request from the owner of a globally unique product identifier may provide the NFT and the signature.

As shown in FIG. 7, client 410 may provide a get request 710 with their private key and/or a code to GUPI mapper 414. Note that the code may be a GS1 Digital Link, a GTIN, an SSCC, an SGTIN, an EAN, a UPC, an EPC, a GLN, an ISBN, a GRAI, a GCN, an ASIN, a GRAI, a GSIN, a UUID, a GDTY, a GUID, an Eddystone UID or EID, an IMEI, an eSIM identifier, a PhPID, an NFT, etc. In response, GUPI mapper 414 may translate the code into an associated NFT, and then may retrieve the data. Notably, GUPI mapper 414 may provide a getDB request 712 with the key and the NFT to decentralized database 430. Then, database 430 may provider a pointer 714 (or associated information) to public metadata and/or private metadata to GUPI mapper 414, and GUPI mapper 414 may provide pointer 716 (or associated information) to the public metadata and/or the private metadata to client 410. Next, client 410 may provide a pointer 718 (or associated information) to a set that includes the private key, the code, the public metadata and/or the private metadata to GUPI mapper 414, which provides pointer 718 (or associated information) to database 430. Moreover, database 430 may provide an acknowledgment (ACK) 720 to GUPI mapper 414.

Table 3 provides pseudocode for a client metadata request with a private key.

TABLE 3
Client −> GUPI mapper: get (key, code)
GUPI mapper −> Database: getDB (key, NFT)
Database −> GUPI mapper: private metadata, public metadata
GUPI mapper −> Client: private metadata, public metadata
Client −> GUPI mapper: set (key, code, private metadata, public
metadata)
GUPI mapper −> Database: setDB (key, NFT, private metadata, public
metadata)
Database −> GUPI mapper: Acknowledgement

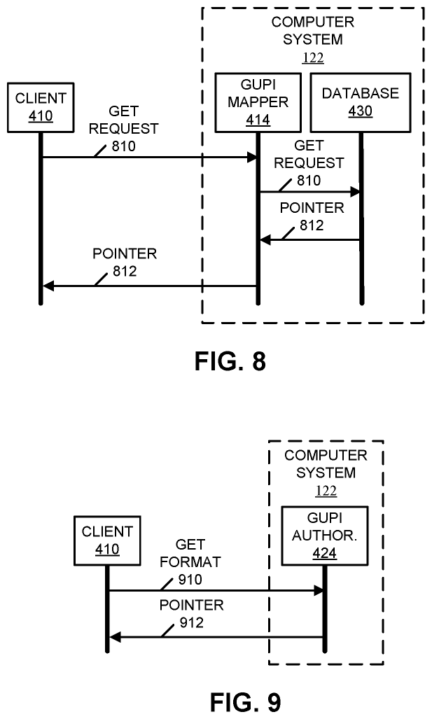

FIG. 8 presents a drawing illustrating an example of requesting metadata associated with a globally unique product identifier without using a private key in accordance with an embodiment of the present disclosure. These operations may, at least in part, be performed by one or more computers in a computer system, such as computer system 122 (FIG. 1).

When authorized by the owner of a globally unique produce identifier, product metadata may be retrieved by one or more clients, e.g., by applications that need to display information about a product. The metadata may be retrieved by sending or providing a transaction to a corresponding smart contract, either with the NFT or with another supported product identifier (such as a globally unique produce identifier). In response, the contract may return the metadata corresponding to the product. Alternatively, the metadata may be obtained by querying a product uniform resource identifier or URI (e.g., a GS1 Digital Link) on a decentralized (e.g., IPFS) data store. In these embodiments, which is depicted in FIG. 8, the public metadata can be retrieved.

As shown in FIG. 8, client 410 may request metadata without a private key by providing get request 810 to GUPI mapper 414, e.g., with a NFT or a globally unique product identifier. In response, GUPI mapper 414 may provide get request 810 to decentralized database 430. Then, database 430 may provide a pointer 812 (or associated information) to the public metadata to GUPI mapper 4141. Next, GUPI mapper 414 provides pointer 812 to the public metadata to client 410.

Table 4 provides pseudocode for a client metadata request without a private key.

TABLE 4

Client −> GUPI mapper: get (code)
GUPI mapper −> Database: get (NFT)
Database −> GUPI mapper: public metadata
GUPI mapper −> Client: public metadata

FIG. 9 presents a drawing illustrating an example of retrieving a globally unique product identifier in accordance with an embodiment of the present disclosure. These operations may, at least in part, be performed by one or more computers in a computer system, such as computer system 122 (FIG. 1).

One challenge that a client may face is how to get a unique printable identifier for their products. This capability may be provided by a translation between a globally unique product identifier or an NFT and a formatted globally unique product identifier for the product.

Notably, as shown in FIG. 9, client 410 may provide a get format 910 with a private key, a globally unique product identifier and a format identifier to GUPI authority 424. In response, GUPI authority 424 may provide a pointer 912 (or associated information) to the formatted globally unique product identifier to client 410. Note that the format of the formatted globally unique product identifier may be compatible with a GS1 Digital Link, a GTIN, an SSCC, an SGTIN, an EAN, a UPC, an EPC, a GLN, an ISBN, a GRAI, a GCN, an ASIN, a GRAI, a GSIN, a UUID, a GDTY, a GUID, an Eddystone UID or EID, an IMEI, an eSIM identifier, a PhPID, etc.

Table 5 provides pseudocode for a client formatted globally unique product identifier retrieval.

TABLE 5

Client −> GUPI authority: get format (key, globally unique

product identifier, format identifier)

GUPI authority −> Client: Formatted globally unique product
identifier

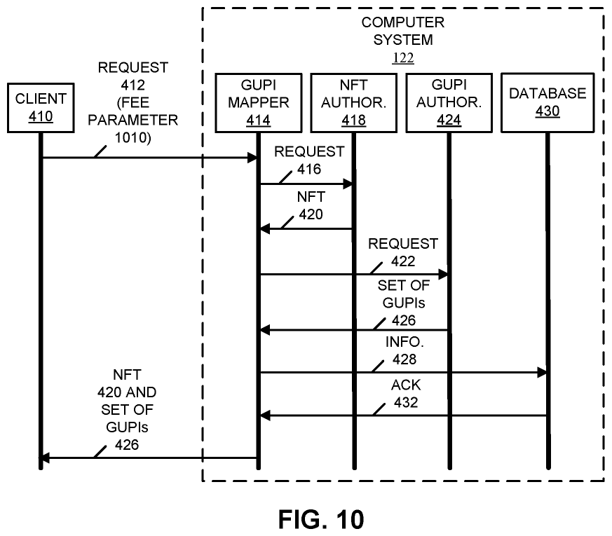

In some embodiments, prior to generating a globally unique product identifier a transaction may be performed to transfer a value (such as a monetary value) or a token corresponding to the value, which is associated with the smart contract. This is shown in FIG. 10 presents a drawing illustrating an example of performing a transaction that transfers value associated with a smart contract in accordance with an embodiment of the present disclosure. These operations may, at least in part, be performed by one or more computers in a computer system, such as computer system 122 (FIG. 1).

Note that a wallet may encompass a private and a public key pair. In the embodiments in the present disclosure, a ‘key’ may be a public portion of a wallet pair. Consequently, in order to monetize one of the disclosed embodiments, a fee parameter may be added to or included in one or more operations, such as one of the smart-contract calls. For example, the fee parameter may be a number uint 256 of a cryptocurrency (e.g., Ether) that a user transfers from their wallet (which can be identified by a public key) to the smart contract (or wallet). The smart contract may only generate one or more NFT(s) if the fee or value is the correct amount (e.g., of cryptocurrency) and the user has the funds on their wallet.

Moreover, the type of cryptocurrency that is transferred may depend on the blockchain platform that is used (e.g., in the case of Ethereum, these may be Ethers). These cryptocurrencies are different from the NFT, which are not a currency, but are tokens that may be provided in exchange for the payment of the currency.

Thus, as shown in FIG. 10, a fee parameter 1010 (such as an amount of cryptocurrency a user is transferring) may be included in their request to have one or more globally unique product identifiers generated and/or reading or updating metadata. Similarly, the pseudocode in Table 1 may be updated, as shown in Table 6, which provides an example pseudocode for the operations shown in FIG. 10. Note that in embodiments where the generating of the one or more globally unique product identifiers generated and/or reading or updating metadata has no associated cost (i.e., is free), fee parameters 1010 may be zero.

TABLE 6

Client −> GUPI mapper: Request (key, count, public metadata,

private metadata, fee parameter)

GUPI mapper −> NFT: Request (key)
NFT −> GUPI mapper: NFT
GUPI mapper −> GUPI authority: (NFT, count)
GUPI authority −> GUPI mapper: {set of GUPIs}
GUPI mapper −> Database: (key, NFT, public metadata, private
metadata)
Database −> GUPI mapper: Acknowledgement
GUPI mapper −> Client: {set of GUPIs}, NFT

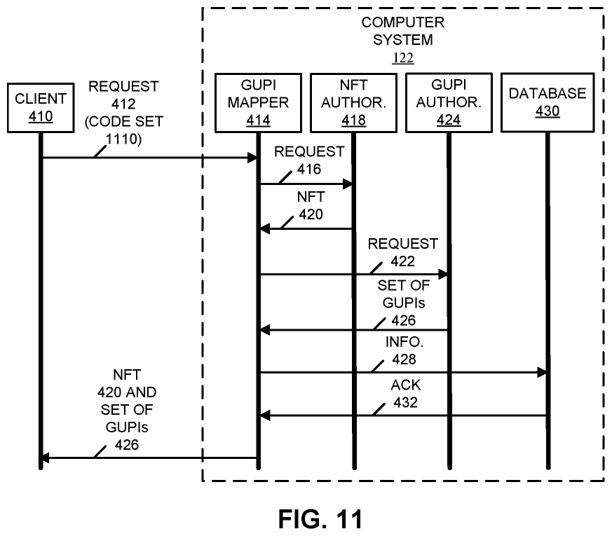

In some embodiments, a client may have a unique identifier (such as a globally unique product identifier) for their product, such as for a diamond or a biometric-based code. This is shown in FIG. 11, which presents a drawing illustrating an example of associating a globally unique product identifier with an NFT in accordance with an embodiment of the present disclosure. These operations may, at least in part, be performed by one or more computers in a computer system, such as computer system 122 (FIG. 1).

In these embodiments, a client may provide a unique identifier or a code (or a set of codes) that that they would like to manage. The operations are similar to those in the previous embodiments, except that {Code1, . . . CodeN}, represented by a code set 1110, may be added. These codes may represent a set that may be an empty set or may include unique identifiers or codes that are to be associated with the returned globally unique product identifier(s) and the NFT.

Moreover, in these embodiments, several use cases may be supported. Notably, if a set with one unique code is received, a single globally unique product identifier and an NFT may be returned. Alternatively, if more than one unique code is received in a set, the count may be checked. When the count is ‘1’, a single globally unique product identifier and an NFT may be associated with the entire set of identifiers or codes. Then, the single globally unique product identifier and the NFT may be returned in the set of globally unique product identifiers. However, if count is greater than ‘1’, the count or elements in the set of globally unique product identifier may be returned, one for each unique identifier or code in code set 1110.

Furthermore, in some embodiments, the code in request 710 (FIG. 7) may include or may be a unique identifier or code for a product that is received from a user or a client in code set 1110. Similarly, in some embodiments, request 810 (FIG. 8) may include a unique identifier or code for a product that is received from a user or a client in code set 1110, instead of a globally unique product identifier or an NFT.

In some embodiments of the processes shown in FIGS. 4-11, there may be additional or fewer operations. Furthermore, the order of the operations may be changed, there may be different operations (such as different information may be input or output) and/or two or more operations may be combined into a single operation.

We now describe embodiments of an electronic device, which may perform at least some of the operations in the identification technique. FIG. 12 presents a block diagram illustrating an example of an electronic device 1200 in accordance with some embodiments, such as electronic device 110, electronic device 112, access point 114, base station 116, one of computers 120, etc. This electronic device includes processing subsystem 1210, memory subsystem 1212, and networking subsystem 1214. Processing subsystem 1210 includes one or more devices configured to perform computational operations. For example, processing subsystem 1210 can include one or more microprocessors, ASICs, microcontrollers, programmable-logic devices, one or more graphics process units (GPUs) and/or one or more digital signal processors (DSPs).

Memory subsystem 1212 includes one or more devices for storing data and/or instructions for processing subsystem 1210 and networking subsystem 1214. For example, memory subsystem 1212 can include dynamic random access memory (DRAM), static random access memory (SRAM), and/or other types of memory. In some embodiments, instructions for processing subsystem 1210 in memory subsystem 1212 include: one or more program modules or sets of instructions (such as program instructions 1222 or operating system 1224), which may be executed by processing subsystem 1210. Note that the one or more computer programs may constitute a computer-program mechanism. Moreover, instructions in the various modules in memory subsystem 1212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1210.

In addition, memory subsystem 1212 can include mechanisms for controlling access to the memory. In some embodiments, memory subsystem 1212 includes a memory hierarchy that comprises one or more caches coupled to a memory in electronic device 1200. In some of these embodiments, one or more of the caches is located in processing subsystem 1210.

In some embodiments, memory subsystem 1212 is coupled to one or more high-capacity mass-storage devices (not shown). For example, memory subsystem 1212 can be coupled to a magnetic or optical drive, a solid-state drive, or another type of mass-storage device. In these embodiments, memory subsystem 1212 can be used by electronic device 1200 as fast-access storage for often-used data, while the mass-storage device is used to store less frequently used data.

Networking subsystem 1214 includes one or more devices configured to couple to and communicate on a wired and/or wireless network (i.e., to perform network operations), including: control logic 1216, an interface circuit 1218 and one or more antennas 1220 (or antenna elements) and/or input/output (I/O) port 1230. (While FIG. 12 includes one or more antennas 1220, in some embodiments electronic device 1200 includes one or more nodes, such as nodes 1208, e.g., a network node that can be coupled or connected to a network or link, or an antenna node or a pad that can be coupled to the one or more antennas 1220. Thus, electronic device 1200 may or may not include the one or more antennas 1220.) For example, networking subsystem 1214 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Networking subsystem 1214 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1200 may use the mechanisms in networking subsystem 1214 for performing simple wireless communication between the electronic devices, e.g., transmitting advertising or beacon frames and/or scanning for advertising frames transmitted by other electronic devices as described previously.

Within electronic device 1200, processing subsystem 1210, memory subsystem 1212, and networking subsystem 1214 are coupled together using bus 1228. Bus 1228 may include an electrical, optical, and/or electro-optical connection that the subsystems can use to communicate commands and data among one another. Although only one bus 1228 is shown for clarity, different embodiments can include a different number or configuration of electrical, optical, and/or electro-optical connections among the subsystems.

In some embodiments, electronic device 1200 includes a display subsystem 1226 for displaying information on a display, which may include a display driver and the display, such as a liquid-crystal display, a multi-touch touchscreen, etc.

Electronic device 1200 can be (or can be included in) any electronic device with at least one network interface. For example, electronic device 1200 can be (or can be included in): a computer system (such as a cloud-based computer system or a distributed computer system), a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a stack of computer network devices, an access point, a controller, test equipment, and/or another electronic device.

Although specific components are used to describe electronic device 1200, in alternative embodiments, different components and/or subsystems may be present in electronic device 1200. For example, electronic device 1200 may include one or more additional processing subsystems, memory subsystems, networking subsystems, and/or display subsystems. Additionally, one or more of the subsystems may not be present in electronic device 1200. Moreover, in some embodiments, electronic device 1200 may include one or more additional subsystems that are not shown in FIG. 12, such as a user-interface subsystem 1232. Also, although separate subsystems are shown in FIG. 12, in some embodiments some or all of a given subsystem or component can be integrated into one or more of the other subsystems or component(s) in electronic device 1200. For example, in some embodiments program instructions 1222 are included in operating system 1224 and/or control logic 1216 is included in interface circuit 1218.

Moreover, the circuits and components in electronic device 1200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1214 (or, more generally, of electronic device 1200). The integrated circuit may include hardware and/or software mechanisms that are used for transmitting wireless signals from electronic device 1200 and receiving signals at electronic device 1200 from other electronic devices. Aside from the mechanisms herein described, radios are generally known in the art and hence are not described in detail. In general, networking subsystem 1214 and/or the integrated circuit can include any number of radios. Note that the radios in multiple-radio embodiments function in a similar way to the described single-radio embodiments.

In some embodiments, networking subsystem 1214 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet, a cellular-telephone communication protocol and a Wi-Fi communication protocol as an illustrative example, in other embodiments a wide variety of communication protocols and, more generally, wired and/or wireless communication techniques may be used. Thus, the identification technique may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the identification technique may be implemented using program instructions 1222, operating system 1224 (such as a driver for interface circuit 1218) or in firmware in interface circuit 1218. Alternatively or additionally, at least some of the operations in the identification technique may be implemented in a physical layer, such as hardware in interface circuit 1218.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the identification technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
a network interface configured to communicate with an electronic device;
a processor; and
memory configured to store program instructions, wherein, when executed by the processor, the program instructions cause the computer system to perform operations comprising:
generating, in a decentralized manner, a globally unique product identifier for a product based at least in part on a smart contract;
associating the globally unique product identifier one-to-one or many-to-one with a non-fungible token (NFT) based at least in part on the smart contract; and
providing the globally unique product identifier intended for the electronic device associated with a recipient.

2. The computer system of claim 1, wherein the globally unique product identifier is configured for global authentication.

3. The computer system of claim 1, wherein the smart contract is based at least in part on a blockchain.

4. The computer system of claim 1, wherein the globally unique product identifier is generated as part of a sequential group of globally unique product identifiers or is generated non-sequentially from another globally unique product identifier.

5. The computer system of claim 1, wherein the NFT is immutable.

6. The computer system of claim 1, wherein the globally unique product identifier is assigned to a set of globally unique product identifiers that are associated with the NFT.

7. The computer system of claim 1, wherein the globally unique product identifier is compatible with one or more of: a GS1 Digital Link, a GTIN, a serial shipping container (SSCC), a serialized global trade item number (SGTIN), an EAN, a UPC, an electronic product code (EPC), a global location number (GLN), an international standard book identifier (ISBN), a global returnable assess identifier (GRAI), a global coupon number (GCN), an Amazon standard identification number (ASIN), a global returnable asset identifier (GRAI), a global shipment identification number (GSIN), a universally unique identifier (UUID), a global document type identifier (GDTY), a globally unique identifier (GUID), an Eddystone UID or EID, an international mobile equipment identity (IMEI), an eSIM identifier, or a pharmaceutical product identifier (PhPID).

8. The computer system of claim 1, wherein the globally unique product identifier is generated randomly or pseudo-randomly.

9. The computer system of claim 1, wherein the operations comprise receiving a request for a desired number of globally unique product identifiers that is associated with the electronic device, and the globally unique product identifier is generated based at least on the request.

10. The computer system of claim 9, wherein, prior to the receiving, the operations comprise performing a transaction that transfers value associated with the smart contract.

11. A non-transitory computer-readable storage medium for use in conjunction with a computer system, the computer-readable storage medium storing program instructions that, when executed by the computer system, causes the computer system to perform operations comprising:
generating, in a decentralized manner, a globally unique product identifier for a product based at least in part on a smart contract;
associating the globally unique product identifier one-to-one or many-to-one with a non-fungible token (NFT) based at least in part on the smart contract; and
providing the globally unique product identifier intended for an electronic device associated with a recipient.

12. The non-transitory computer-readable storage medium of claim 11, wherein the globally unique product identifier is configured for global authentication.

13. The non-transitory computer-readable storage medium of claim 11, wherein the smart contract is based at least in part on a blockchain.

14. The non-transitory computer-readable storage medium of claim 11, wherein the globally unique product identifier is generated as part of a sequential group of globally unique product identifiers or is generated non-sequentially from another globally unique product identifier.

15. The non-transitory computer-readable storage medium of claim 11, wherein the NFT is immutable.

16. The non-transitory computer-readable storage medium of claim 11, wherein the globally unique product identifier is compatible with one or more of: a GS1 Digital Link, a GTIN, a serial shipping container (SSCC), a serialized global trade item number (SGTIN), an EAN, a UPC, an electronic product code (EPC), a global location number (GLN), an international standard book identifier (ISBN), a global returnable assess identifier (GRAI), a global coupon number (GCN), an Amazon standard identification number (ASIN), a global returnable asset identifier (GRAI), a global shipment identification number (GSIN), a universally unique identifier (UUID), a global document type identifier (GDTY), a globally unique identifier (GUID), an Eddystone UID or EID, an international mobile equipment identity (IMEI), an eSIM identifier, or a pharmaceutical product identifier (PhPID).

17. The non-transitory computer-readable storage medium of claim 11, wherein the operations comprise receiving a request for a desired number of globally unique product identifiers that is associated with the electronic device, and the globally unique product identifier is generated based at least on the request.

18. The non-transitory computer-readable storage medium of claim 17, wherein, prior to the receiving, the operations comprise performing a transaction that transfers value associated with the smart contract.

19. A method for generating a globally unique produce identifier, comprising by a computer system:
generating, in a decentralized manner, the globally unique product identifier for a product based at least in part on a smart contract;
associating the globally unique product identifier one-to-one or many-to-one with a non-fungible token (NFT) based at least in part on the smart contract; and
providing the globally unique product identifier intended for an electronic device associated with a recipient.

20. The method of claim 19, wherein the smart contract is based at least in part on a blockchain.
